(19) United States
(12) Patent Application Publication
(10) Pub. No.: US 2025/0261023 A1
(43) Pub. Date: Aug. 14, 2025

(54) SYSTEMS AND METHODS FOR USER-EQUIPMENT-BASED INTEGRATED COMMUNICATION AND SENSING

(71) Applicant: APPLE INC., Cupertino, CA (US)

(72) Inventors: Benedikt Schweizer, Munich (DE); Oghenekome Oteri, San Diego, CA (US); Mona Agnel, Guildford (GB); Alexander Sirotkin, Hod Hasharon (IL); Bertram R. Gunzelmann, Koenigsbrunn (DE)

(21) Appl. No.: 19/048,565

(22) Filed: Feb. 7, 2025

Related U.S. Application Data
(60) Provisional application No. 63/551,130, filed on Feb. 8, 2024.

(51) Int. Cl. H04W 24/10; H04L 5/00; H04L 41/0803

(52) U.S. Cl. CPC H04W 24/10; H04L 5/0007; H04L 41/0803

(57) ABSTRACT

Systems and methods for user equipment (UE)-based integrated communication and sensing are discussed herein. A UE receives, from a transmission reception point (TRP), a configuration for a sensing signal and an identification of the one or more resources for a transmission of the sensing signal; receives, from the TRP, a sensing signal activation command that triggers the UE to perform the transmission of the sensing signal; performs, in response to the sensing signal activation command, the transmission of the sensing signal; performs a sensing measurement of the sensing signal; and processes the sensing measurement into a sensing result. In some embodiments, the UE sends the sensing result to a sensing management function (SeMF). Corresponding behaviors for the TRP and SeMF are also discussed.

### CROSS-REFERENCE TO RELATED APPLICATION

This application claims the benefit of U.S. Provisional Patent Application No. 63/551,130, filed Feb. 8, 2024, which is hereby incorporated by reference herein in its entirety for all purposes.

### TECHNICAL FIELD

This application relates generally to wireless communication systems, including wireless communication systems implementing UE-centric integrated sensing and communication (ISAC).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that clement is first introduced.

FIG. 1 illustrates a message call flow for UE-centric monostatic sensing, according to embodiments discussed herein.

FIG. 2 illustrates a message call flow for UE-centric bistatic sensing, according to embodiments discussed herein.

FIG. 3 illustrates a method of an SeMF, according to embodiments discussed herein.

FIG. 4 illustrates a method of a TRP, according to embodiments discussed herein.

FIG. 5 illustrates a method of a UE, according to embodiments discussed herein.

FIG. 6 illustrates a method of an SeMF, according to embodiments discussed herein.

FIG. 7 illustrates a method of a UE, according to embodiments discussed herein.

FIG. 8 illustrates a method of a UE, according to embodiments discussed herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### UE-Centric Integrated Sensing and Communication (ISAC)

Integrated sensing and communication (ISAC) is a capability and usage scenario that facilitates/enables various useful applications and services that use sensing capabilities. ISAC use cases contemplate that a transmitting device performs a transmission of a sensing signal (sometimes referred to herein as a “waveform”) within a usage environment. The sensing signal interacts with the environment (e.g., with one or more objects in the environment) and is modified through that interaction. A receiving device correspondingly receives/measures the sensing signal as modified by the environment. A device provided with this measurement information as received uses it to draw one or more conclusions about the environment (e.g., about location(s), size(s), motion(s), etc., of one or more objects in the environment). ISAC enables, among other things, wide area multi-dimensional sensing that provides spatial information about unconnected objects and/or connected devices and their movements and surroundings.

Corresponding to ISAC frameworks discussed herein, “monostatic sensing” refers to an architecture with co-located transmitter and receiver. In some cases, the transmitter and receiver share a common oscillator. One example of a monostatic sensing case is a case where a UE transmits and receives a waveform simultaneously.

Further, “bistatic sensing” refers to an architecture where a transmitter and receiver are separated on two devices that do not share a common oscillator. One example of a bistatic sensing case is a case where a first UE transmits a waveform and a second UE receives the waveform. Bistatic sensing may be uni-directional (e.g., in the sense of device 1 to device 2) or bi-directional (e.g., with both devices acting as transmitters and receivers in a coordinated fashion).

As used herein, “multistatic sensing” may be contemplated as a generalization/extension of bistatic sensing with more than two participating nodes.

Various architectures and/or protocols that enable sensing in the context of existing and/or upcoming RAT types (e.g., 5G, 6G) may be contemplated. It will be understood that the terms sensing management function (SeMF), transmission reception point (TRP), LTE positioning protocol (LPP) and/or NR positioning protocol A (NRPPa) and their extensions as may be used herein to support the discussion of UE-centric sensing should be understood in the sense that these are/would be analogously applicable to/within these various other protocols and architectures.

### Embodiments Using Monostatic Sensing

For various monostatic cases discussed herein, it may be that a UE is configured to perform transmission of one or more sensing signals and to receive and measure those same sensing signals as reflected/scattered. Further, it may be that one or more than one UE(s) performs such transmitting and sensing simultaneously. In some cases, multiple UEs may be configured to perform monostatic sensing in a coordinated way. This coordination may be a task performed by an SeMF. However, in some cases, at least some related decisions (e.g., resource allocation decisions, sensing signal definition decisions, and/or resource scheduling decisions) may be “offloaded” to TRP(s)/base station(s) and/or performed jointly by an SeMF and TRP(s)/base station(s).

Various embodiments described herein assume that there are multiple UEs performing monostatic sensing. Note that in alternative cases involving only a single UE, a message call flow may be similar to that for a multiple UE case, but with a difference that the SeMF and/or the base station/TRP experiences reduced complexity in assigning resources for the monostatic sensing.

In monostatic sensing cases involving multiple UEs, the sensing signal of each individual UE may be orthogonal to all other signals this UE may receive (e.g., sensing signals or other signals of other UEs/TRPs in the same or neighboring cells) in order to minimize interference caused by such transmissions.

Measurements taken corresponding to such monostatic sensing embodiments may be collected by the SeMF. The SeMF may perform further evaluation, aggregation, and/or fusion of multiple such measurements and make any results available to a customer (e.g., a location services (LCS)/sensing client).

In some embodiments, the monostatic sensing may be initiated by an external client located/operating on a UE that performs the monostatic sensing. In such a case, the results may be made available directly at the UE without going through an SeMF.

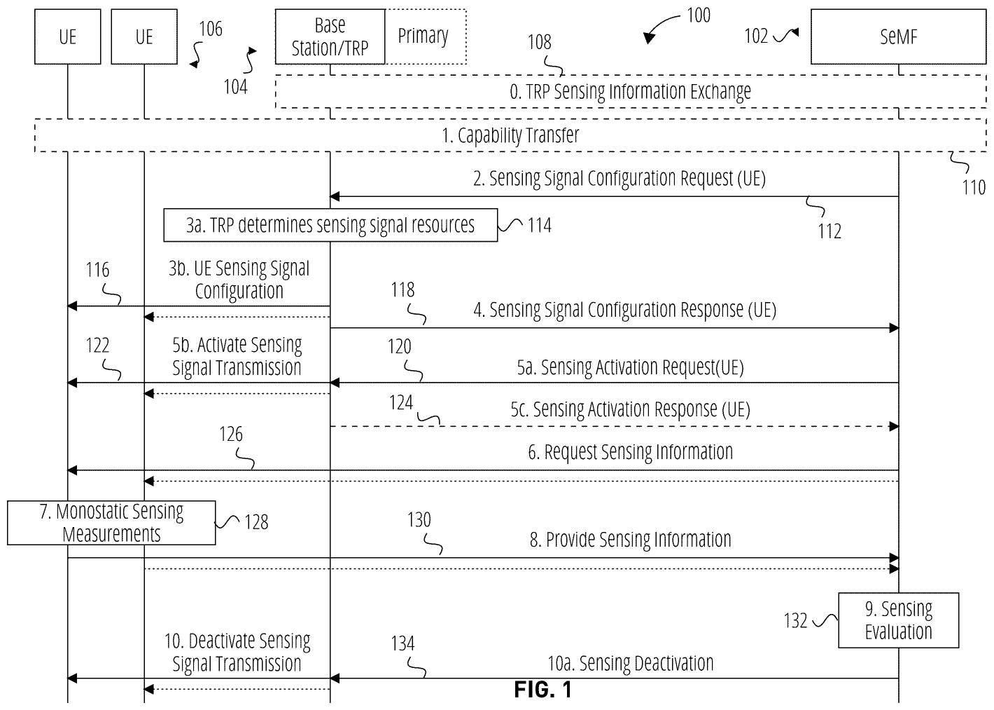

FIG. 1 illustrates a message call flow 100 for UE-centric monostatic sensing, according to embodiments discussed herein. The message call flow 100 illustrates communications between an SeMF 102, a base station/TRP 104, and UE(s) 106. As illustrated, the base station/TRP 104 may be a primary base station/TRP.

Further, note that while the message call flow 100 explicitly illustrates the UE(s) 106 as multiple UEs, it will be understood that the message call flow 100 operates analogously in the event that there is only a single UE in the UE(s) 106. Accordingly, reference to the UE(s) 106 of FIG. 1 should be understood to contemplate/include the case of a single UE in the UE(s) 106.

Finally, note that while various elements of the message call flow 100 will be discussed at some level here, additional details about these elements can be found elsewhere in this disclosure.

Preliminarily, an exchange 108 of operational parameters and sensing capabilities may be carried out between the SeMF 102 and the base station/TRP 104. Further, a transfer 110 of sensing capabilities from the UE(s) 106 to the SeMF 102 may occur.

Then, the SeMF 102 sends 112 a sensing signal configuration request for the UE(s) 106 to the base station/TRP 104 that serves the UE(s) 106. The sensing signal configuration request may include proposed configuration(s) for sensing signal(s) to be used by the UE(s) 106 for monostatic sensing.

Note that while the message call flow 100 uses a case where each of the UE(s) 106 is served through a same base station/TRP 104, this is not strictly required. In cases where the target UEs are neighboring UEs that are served through different base stations/TRPs, multiple sensing signal configuration requests may be used (one per base station/TRP), and the configurations requested by these messages may be such arranged such that interference between UEs served by different TRPs is minimized (e.g., the requested configurations for the UEs may use orthogonal resource sets). The SeMF may be responsible to ensure this, which in some cases corresponds to the use of multiple iterations of, for example, elements 1 to 4 of the message call flow 100, as shown. The SeMF further considers neighboring TRPs and their configurations during this step to avoid interference caused by transmissions by TRPs and/or UEs in neighboring cells.

In the event that the base station/TRP 104 finds the proposed configuration(s) for the UE(s) 106 from the sensing signal configuration request acceptable, the base station/TRP 104 determines 114 suitable sensing resources for the UE(s) 106. The base station/TRP 104 then configures 116 the UE(s) that perform sensing (the UE(s) 106) with a suitable sensing signal according to the configuration(s) received from the SeMF 102 and within the sensing resources determined by the base station/TRP 104.

The base station/TRP 104 then sends 118 the SeMF 102 a sensing signal configuration response that confirms the sensing signal configuration(s) of the UE(s) 106 to the SeMF 102. Note that in an alternative case where one or more proposed configuration(s) of a sensing signal configuration request provided to a base station/TRP from an SeMF is not acceptable to the base station/TRP, the sensing signal configuration response message type may instead be used to provide an alternative configuration suggestion to the SeMF.

The SeMF 102 then sends 120 the base station/TRP 104 a sensing activation request to activate transmission(s) of sensing signal(s) by the UE(s) 106. In response to receiving the sensing activation request, the base station/TRP 104 sends 122 the UE(s) 106 sensing signal activation command(s) that cause the UE(s) 106 to perform the corresponding transmission(s) of the sensing signal(s).

In some embodiments, the base station/TRP 104 then optionally sends 124 the SeMF 102 a sensing activation response acknowledging that the transmission(s) by the UE(s) 106 have been activated.

Then, the SeMF 102 sends 126 the UE(s) 106 sensing information request(s) that triggers the UE(s) 106 to perform measurements of their transmission(s) (e.g., to perform monostatic-sensing-based measurements of their own transmission(s)). The sensing information request(s) may also be used to request delivery of sensing information, including measurement results, from the UE(s) 106 to the SeMF 102.

Note that in some alternative cases, sensing information request(s) may not be used, and one or more of the UE(s) 106 may trigger measurements by themselves (e.g., responsive to receiving a sensing activation request from the base station/TRP 104).

The UE(s) 106 then proceed to perform 128 monostatic sensing measurement(s) on their transmitted sensing signals.

The UE(s) 106 then send 130 sensing information including sensing result(s) to the SeMF 102 (e.g., as requested or as otherwise configured). In some cases, the sensing results include raw data from the UE(s) 106. In some cases, the sensing result(s) are (pre)-processed by the UE(s) 106 prior to being sent to the SeMF 102. In some cases, the sensing result(s) are sent along with additional meta information.

Note also that, in some alternative embodiments, a UE may utilize the sensing results directly and/or send the send results to a peer UE rather than and/or in addition to sending them to the SeMF 102.

Then, the SeMF 102 performs 132 sensing evaluation based on the receive sensing result(s). In cases where the UE(s) 106 include multiple UEs, the SeMF 102 may combine sensing results from these multiple UEs. Then the SeMF may the (optionally) make the sensing result(s) available to, for example, an LCS/sensing client.

The SeMF 102 then sends 134 the UE(s) 106 sensing deactivation message(s) that deactivate sensing activity by the UE(s) 106 (including, e.g., a stopping of the transmission of sensing signals). The SeMF 102 may send the sensing deactivation message(s) to the UE(s) 106 in response to a request to deactivate sensing by an external client.

Note that in alternative embodiments for monostatic sensing, a sensing signal activation command (refer to element 5b of the message call flow 100) and a sensing information request (refer to element 6 of the message call flow 100) may be combined into a single message. As another alternative, a UE may perform measurements as soon as/in response to a sensing signal activation command is received, without waiting for a sensing information request. Such cases may correspond to embodiments where, for example, the external client that is the ultimate requester/impetus for the monostatic sensing behavior is located on the UE that is performing the monostatic sensing.

### Embodiments Using Bistatic Sensing

For various bistatic sensing cases discussed herein, at least one UE is configured to transmit sensing signals, and one or more other UEs are configured to receive those reflected/scattered sensing signals. In some cases, such behavior may be “uni-directional” (e.g., where one or more UEs act to transmit sensing signals and other (different) UEs act to receive sensing signals). In other cases, such behavior may be “bi-directional” (e.g., where one or more UEs have the role of both transmitter and receiver in an alternating and/or intertwined fashion).

Some embodiments discussed herein are presented for the general bi-directional case, where multiple UEs are configured to both transmit and receive sensing signals. The corresponding coordination may be a task handled by an SeMF; however, some related decisions (e.g., resource allocation, sensing signal definition, and/or scheduling of resources) may be “offloaded” to a TRP/base station or performed jointly by both an SeMF and a TRP/base station.

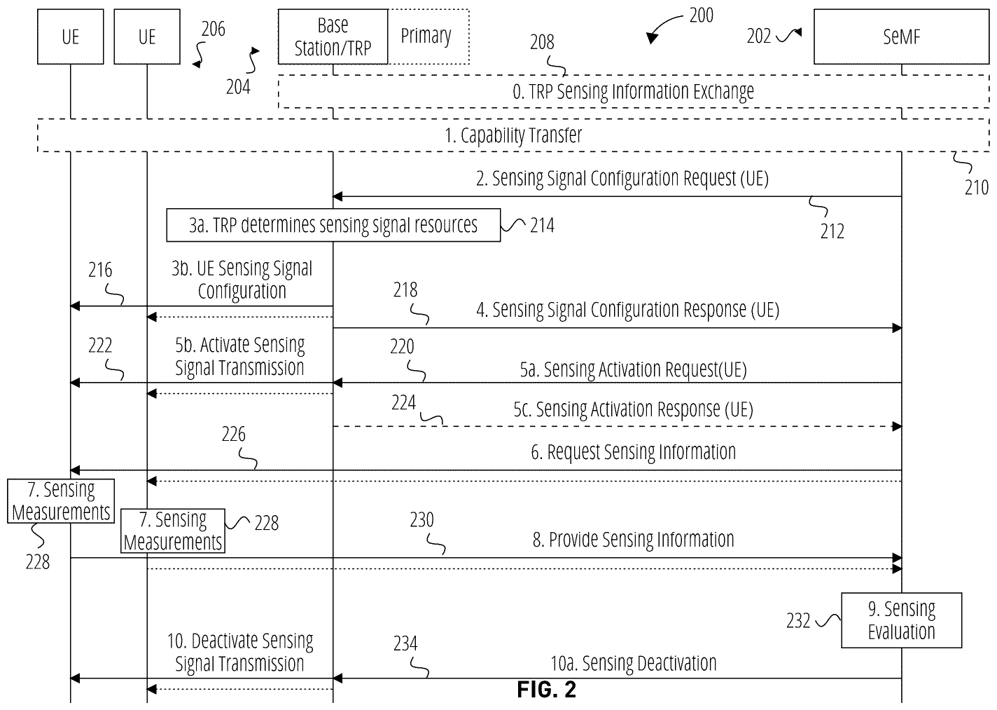

Note that in cases of uni-directional sensing, a message call flow for bistatic sensing (e.g., as in FIG. 2 to be discussed) may be understood to represent a case where one UE only transmits while other UE(s) only receive. Nevertheless, it may be in such cases that all UEs provide sensing information that includes assistance data of the transmitting UEs (e.g. position, orientation, time stamp, angular information, etc.).

Even in the case of uni-directional sensing, a sensing signal of each individual UE may be configured to be orthogonal to other signals a receiving UE is able to receive, in order to minimize interference (e.g., as may be caused by transmissions of other UEs and/or base stations/TRPs in the same or neighboring cells).

Measurements taken corresponding to such embodiments may be collected by the SeMF. The SeMF may then perform further evaluation, aggregation, and/or fusion of multiple such measurements and make any results available to a customer (e.g., a location services (LCS)/sensing client).

FIG. 2 illustrates a message call flow 200 for UE-centric bistatic sensing, according to embodiments discussed herein. The message call flow 200 illustrates communications between an SeMF 202, a base station/TRP 204, and UEs 206. As illustrated, the base station/TRP 204 may be a primary base station/TRP.

Further, note that while various elements of the message call flow 200 will be discussed at some level here, additional details about these elements can be found elsewhere in this disclosure.

Preliminarily, an exchange 208 of operational parameters and sensing capabilities may be carried out between the SeMF 202 and the base station/TRP 204. Further, a transfer 210 of sensing capabilities from the UEs 206 to the SeMF 202 may occur.

Then, the SeMF 202 sends 212 a sensing signal configuration request for the UEs 206 to the base station/TRP 204 that serves the UEs 206. The sensing signal configuration request may include proposed configuration(s) for sensing signal(s) to be used by the UEs 206 for bistatic sensing.

Note that while the message call flow 200 uses a case where each of the UEs 206 is served through a same base station/TRP 204, this is not strictly required. In cases where the target UEs are neighboring UEs that are served through different base stations/TRPs, multiple sensing signal configuration requests may be used (one per base station/TRP), and the configurations requested by these messages may be such arranged such that interference between UEs served by different TRPs is minimized (e.g., the requested configurations for the UEs may use orthogonal resource sets). The SeMF may be responsible to ensure this, which in some cases corresponds to the use of multiple iterations of, for example, elements 1 to 4 of the message call flow 200, as shown. The SeMF further considers neighboring TRPs and their configurations during this step to avoid interference caused by transmissions by TRPs and/or UEs in neighboring cells.

In the event that the base station/TRP 204 finds the proposed configuration(s) for the UEs 206 from the sensing signal configuration request acceptable, the base station/TRP 204 determines 214 suitable sensing resources for the UEs 206. The base station/TRP 204 then configures 216 the ones of the UEs 206 that are to transmit sensing signals with a suitable sensing signal according to the configuration(s) received from the SeMF 202 and within the sensing resources determined by the base station/TRP 204. Further, the base station/TRP 204 also configures the ones of the UEs 206 that are to receive the sensing signals with information needed to receive (and potentially process) the sensing signals.

The base station/TRP 204 then sends 218 the SeMF 202 a sensing signal configuration response that confirms the sensing signal configuration(s) of the UEs 206 to the SeMF 202. Note that in an alternative case where one or more proposed configuration(s) of a sensing signal configuration request provided to a base station/TRP from an SeMF is not acceptable to the base station/TRP, the sensing signal configuration response message type may instead be used to provide an alternative configuration suggestion to the SeMF.

The SeMF 202 then sends 212 the base station/TRP 204 a sensing activation request to activate transmission(s) of sensing signal(s) by the ones of the UEs 206 the perform sensing signal transmission. In response to receiving the sensing activation request, the base station/TRP 204 sends 212 the ones of the UEs 206 that are to perform sensing signal transmission sensing signal activation command(s) that cause those UEs to perform the corresponding transmission(s) of the sensing signal(s).

In some embodiments, the base station/TRP 204 then optionally sends 224 the SeMF 202 a sensing activation response acknowledging that the transmission(s) by the ones of the UEs 206 that are to transmit sensing signals have been activated.

Then, the SeMF 202 sends 226 the ones of the UEs 206 that are to receive sensing signals sensing information request(s) that configure those UEs with information required to receive (and potentially process) the sensing signals (e.g., to perform bistatic-sensing-based measurements of the sensing signals transmitted by others of the UEs 206). The sensing information request(s) may also be used to request delivery of sensing information, including measurement results, from either/both transmitting UEs (in which case these also receive sensing information request(s)) and/or receiving UEs to the SeMF 202.

The ones of the UEs 206 that are configured to receive sensing signals then proceed to perform 228 bistatic sensing measurement(s) on the sensing signal transmitted by others of the UE(s).

The UEs 206 then send 230 sensing information to the SeMF 202. For ones of the UEs 206 that receive sensing signals, this sensing information may include collected sensing result(s) measured according to the use of bistatic sensing (e.g., as requested or as otherwise configured). In some cases, the sensing results include raw data from the UEs 206. In some cases, the sensing result(s) are (pre)-processed by the UEs 206 prior to being sent to the SeMF 202. In some cases, the sensing result(s) are sent along with additional meta information. Note that as part of this process, the UEs 206 (including either/both of the ones of the UEs 206 that perform sensing signal transmission and/or the ones of the UEs 206 that perform sensing signal reception) may send relevant sensing assistance information to the SeMF 202 as well.

Note also that, in some alternative embodiments, a UE may utilize the sensing results directly and/or send the send results to a peer UE rather than and/or in addition to sending them to the SeMF 202.

Then, the SeMF 202 performs 232 sensing evaluation based on the received sensing result(s). In cases where the ones of the UEs 206 that receive sensing signals include multiple UEs, the SeMF 202 may combine sensing results from these multiple UEs. The SeMF may then (optionally) make the sensing result(s) available to, for example, an LCS/sensing client.

The SeMF 202 then sends 234 the UEs 206 sensing deactivation message(s) that deactivate sensing activity by the UEs 206 (including, e.g., a stopping of the transmission of sensing signals by the ones of the UEs 206 that perform such transmissions and/or a stopping of measurements of the sensing signals by ones of the UEs 206 that configured to receive the sensing signals). The SeMF 202 may send the sensing deactivation message(s) to the UEs 206 in response to a request to deactivate sensing by an external client.

Note that while the discussion of the message call flow 200 discusses ones of the UEs 206 that perform sensing signal transmission and ones of the UEs 206 that perform sensing signal reception/measurement, it should be understood that any one or more of the UEs 206 could perform both roles. In other words, any one or more of the UEs 206 could be operated to both transmit a first sensing signal as described and receive a second sensing signal from another of the UEs 206, and perform corresponding measurement, processing, and/or reporting behaviors for the received/measured sensing signal from the other UE, as described.

For cases of bistatic and/or multistatic sensing, in various embodiments, a receiving UE is configured with sufficient details to receive the sensing signal. This configuration may be included in a sensing signal configuration from a base station/TRP (refer to element 3b of the message call flow 200), shared in a separate message, included in a sensing information request from an SeMF (refer to element 6 of the message call flow 200), and/or any combination of these options.

Further, it is noted that an ordering of multiple bistatic sensing signal transmissions in bistatic sensing cases may depend on the actual sensing signal that is used. An integration level used may extend anywhere from/between a clearly separated transmission use cases (with messages asking for each individual transmission) to a fully coordinated transmission use case. These exchanges may happen one after the other, simultaneously, interleaved in any domain, and/or in any other form of orthogonal signal transmission.

### Generalization Notes

Note that various particulars of protocols for communications between an SeMF and a UE may use/represent extensions of an existing positioning protocol (e.g., an LPP or a 6G RAT equivalent) and/or may use elements of a separate/new protocol that is dedicated for the performance of sensing as described herein. Such protocols may refer to sidelink positioning protocol (SLPP) design (e.g., as used in 5G RAT).

Further, the use of current embodiments within the context of a different/new sidelink (SL) positioning/sensing protocol that is defined for, for example, 6G RAT, are also contemplated (e.g., corresponding to elements 6 and 8 of the message call flow 200). Such protocols may be designed to be transferred via SL (e.g., when a UE is used out of coverage) or via non-access stratum NAS (when the UE is used in coverage).

Note that embodiments discussed herein can be generalized to the case where, within a given group of UEs, monostatic and bistatic sensing are simultaneously used. In such a case, one or more UEs may be configured to transmit sensing signals, and both those same UEs and one or more other UE(s) are configured to receive those sensing signals.

It is contemplated that one or more UEs could transmit a sensing signal and both 1) receive its own signal (monostatic sensing) and 2) receive a signal transmitted by another UE (bistatic sensing). For such cases, strict coordination and assignment of orthogonal resource sets may be observed.

### Example Details for Messaging Content

Additional example details for various elements/messages used/described in relation to the message call flow 100 and/or the message call flow 200 as discussed herein are now provided.

Example details for an exchange of operational parameters and sensing capabilities between a base station/TRP and an SeMF are now given (refer to, e.g., element 0 in each of the message call flow 100 of FIG. 1 and the message call flow 200 of FIG. 2).

This messaging serves the purpose of exchanging operational parameters and capabilities between the base station/TRP and the SeMF. A focus of such messaging is on base station/TRP capabilities for the support of monostatic and/or bistatic sensing at/between UE(s).

Various such capabilities include: sensing methods (monostatic/bistatic) with which the base station/TRP is able to configure a UE; specific aspects of a particular sensing method; specific aspects common for all sensing methods; supported carrier frequencies; supported bandwidth configurations; aspects to configure a UE to receive and potentially process/utilize sensing signals transmitted by other UEs and/or TRPs; and/or supported sensing signal configurations.

The messaging exchange begins when the SeMF sends a TRP Sensing Information Request message to the base station/TRP. Note that this message may indicate/request only specific capabilities of the base station/TRP, or it may indicate/request all capabilities of the base station/TRP. Then, the UE responds with TRP Sensing Information Response message containing the requested information. This message exchange may be carried over NRPPa.

Example details for a transfer of sensing capabilities between a UE and an SeMF are now given (refer to, e.g., element 1 in each of the message call flow 100 of FIG. 1 and the message call flow 200 of FIG. 2).

This messaging serves the purpose of informing the base station/TRP and the SeMF about capabilities of the UE. The capabilities may include: supported sensing methods (monostatic/bistatic); specific aspects of a particular sensing method; specific aspects common for all sensing methods; supported carrier frequencies; supported bandwidth configurations; deployment options (e.g. number, location and orientation of antennas/panels); supported pre-processing steps; supported formats of sensing results; supported sensing assistance data; supported sensing signals; supported transmit/receive configurations; full-duplex capabilities; required gaps between transmission and reception; timing-related parameters, synchronization aspects, and/or accuracy; and/or sensing key performance indicators (KPIs) that may be achieved by the UE such as accuracy, resolution, and/or periodicity.

The messaging exchange begins when the SeMF sends a Request Capabilities message. This message may indicate/request only specific capabilities of the UE, or it may indicate/request all capabilities of the UE. The UE then responds with a Provide Capabilities message containing the requested information. This message exchange may be carried over LPP.

Example details for 1) a sensing signal configuration request from an SeMF to a base station/TRP and 2) a sensing signal configuration response from the base station/TRP to the SeMF are now given (refer to, e.g., elements 2 and 4 in each of the message call flow 100 of FIG. 1 and the message call flow 200 of FIG. 2).

This messaging serves the purpose of configuring the sensing signals of UE(s) that act as sensing signal transmitters. The configuration of neighboring UEs may be such that interference as between them/their base stations/TRPs is minimized (e.g., neighboring UEs may be configured with orthogonal resource sets). An SeMF may be responsible to ensure this (which in some cases may require multiple iterations of elements 2 through 4 corresponding to the message call flow 100 and/or the message call flow 200). The SeMF further considers neighboring TRPs and their configurations during this step to avoid interference caused by transmissions of TRPs and/or UEs in neighboring cells.

Information to be considered by the SeMF in formulating a sensing signal configuration request may include requirements of the initiator/external client. Such requirements may include: type of sensing; quality of service (QoS) requirements; requested feature/type of information/result; and/or KPIs such as accuracy, resolution in range/velocity/angle, angular configuration, etc. Note that in some such cases, requirements may be provided to the SeMF explicitly in the form of physical parameters (e.g., bandwidth, resolution), while in other such cases the requirement are inferable from indicated QoS requirements (that are then translated to signal properties by the SeMF).

A sensing signal configuration request may include an identification of a sensing signal to use. In some cases, an existing reference signal, such as a positioning reference signal (PRS) or a sounding reference signal (SRS), or some newly defined reference signal may be used as a sensing signal. In some cases, the sensing signal configuration request may request the double-use/re-use of some of these or other communication reference signals, a specific sensing signal, or for a double-use of communication data as a sensing signal. In some cases, a number and form of MIMO streams used for the sensing signal is indicated.

A sensing signal configuration request may include an indication of a realization/identifier (ID) of a sensing signal to use. For example, a resource set ID/a particular realization of a comb-like structure may be provided. As another example, a sequence/code (possibly as based on pre-defined sequences with IDs for each realization) for the sensing signal may be indicated.

A sensing signal configuration request may include information about angular domain coverage of the sensing signal. For example, information about a selection of beams to be used, an area and/or beams of interest, and/or a number of transmit (Tx)/receive (Rx) antennas to use in the case of for MIMO radar sensing (imaging radar), etc., may be provided.

A sensing signal configuration request may include parameters for the sensing signal (e.g., frequency, range, bandwidth/carrier aggregation, carrier frequency, etc.).

The corresponding messaging exchange begins when an SeMF sends a SENSING SIGNAL CONFIGURATION REQUEST message to the base station/TRP. Then, the base station/TRP responds with a SENSING SIGNAL CONFIGURATION RESPONSE message that confirms that the provided configuration has been carried out. This message exchange may be carried over NRPPa or some other sensing protocol.

Example details for a sensing signal configuration provided by a base station/TRP to a UE are now given (refer to, e.g., clement 3b in each of the message call flow 100 of FIG. 1 and the message call flow 200 of FIG. 2).

This messaging is transmitted by a base station/TRP to either/both of UEs that transmit sensing signals and/or UEs that receive the transmitted sensing signals. The sensing signal configuration configures the sensing signal according to a SENSING SIGNAL CONFIGURATION REQUEST from the SeMF (refer to, e.g., element 2 of the message call flow 100 and the message call flow 200) and is based on the resources determined by the base station/TRP (refer to, e.g., element 3a of the message call flow 100 and the message call flow 200).

A sensing signal configuration provided to a UE that is used to transmit a sensing signal configures that UE to perform the transmission of the sensing signal. A sensing signal configuration provided to a UE that is used to receive a sensing signal configures that UE to receive (and potentially evaluate) the sensing signal.

The message includes any of the configuration information previously provided to the base station/TRP from an SeMF in a sensing signal configuration request (and/or refinements thereof). The configuration may include, for example: grants for specific transmissions; timing-related parameters for transmission; definition(s) of signal(s) to be transmitted within the grant, including angular information (e.g., as related to MIMO and/or beamforming); and/or definition(s) of sensing signals with information that facilitates the reception and/or processing of the signals for a UE that receives the sensing signal.

The corresponding messaging exchange occurs when a base station/TRP sends a UE a Sensing Signal Configuration message. This messaging exchange may occur over NRPPa or some other sensing protocol.

Example details for 1) a sensing activation request from an SeMF to a base station/TRP and 2) a sensing signal activation command from a base station/TRP to a UE are now given (refer to, e.g., elements 5a and 5b in each of the message call flow 100 of FIG. 1 and the message call flow 200 of FIG. 2).

This messaging activates the transmission/reception of the configured sensing signal at all UE(s) that act as sensing signal transmitters. In monostatic sensing, it may further initiate sensing measurements by the target UE(s). Parameters that may be used by this messaging include: periodicity information (e.g., periodic, aperiodic, semi-persistent, single-shot, etc.) and/or start time/start frame ID information.

The corresponding messaging exchange begins when an SeMF sends a SENSING ACTIVATION REQUEST message to a base station/TRP. Then, the base station/TRP sends an Activate Sensing Signal Transmission message to a UE. In at least some cases, the base station/TRP then sends a SENSING ACTIVATION RESPONSE message back tot he SeMF. This messaging exchange may be carried over LPP/NRPPa or some other sensing protocol.

Example details for 1) a sensing information request from an SeMF to a UE and 2) the transmission of sensing information from the UE to the SeMF are now given (refer to, e.g., elements 6 and 8 in each of the message call flow 100 of FIG. 1 and the message call flow 200 of FIG. 2).

This messaging serves the purpose of starting measurements at UE(s) that act as sensing signal receivers. Additionally, it informs each such receiving UE about types of data that it is to share with the SeMF (e.g., in terms of raw data, (pre-processed) sensing measurements, sensing assistance data, timestamps, etc.).

Some possible options for this sensing information exchange as between cases of monostatic sensing and bistatic sensing are now discussed. Under monostatic sensing, an explicit message to request a start of the measurements may not be sent. Instead, the UE performs measurements on its own sensing signal transmissions as scheduled (refer to, e.g., element 4 of the message call flow 100 and the message call flow 200) and reports results as requested.

Under bistatic sensing, a sensing information request from an SeMF to a UE that transmits a sensing signal serves the purpose of triggering transmission of assistance data (e.g. position and orientation of that UE) to the SeMF.

In some cases, it may be that only one sensing information request message that triggers multiple sensing measurements and responses is used (e.g., in the form of “Provide Sensing Information message(s)”). Note that in some cases, multiple reports may be combined in into one Provide Sensing Information message.

A sensing information request may include an indication of a type of measurement to perform. For example, the sensing information request may indicate for a single-shot measurement type, a semi-persistent measurement type, a periodic measurement type, etc.

A sensing information request may include an indication of a type of requested sensing result. For example, the sensing information request may indicate for a channel state information (CSI) sensing result, a range-doppler-(2D) angle (or a subset thereof) sensing result, and/or a feature sensing result (such as an indication of how crowded an area is, an indication of a weather condition in an area, etc.). In some cases, a sensing information request may indicate that no reporting of any sensing result is wanted.

A sensing information request may include an indication of sensing assistance data that is to be reported. Possible types of such assistance data include, for example, time stamp assistance data, sensor information assistance data, deployment information assistance data, and/or hardware information assistance data. In such cases, any assistance data may be accompanied with some accuracy metric. In some embodiments, the sensing information request indicates that no assistance data is to be reported.

A sensing information request may include a type of report requested (e.g., an individual report type, a combined report type, a threshold-based report type, etc.).

The corresponding messaging exchange begins when an SeMF sends a Request Sensing Information message to a UE. The, the UE responds with a Provide Sensing Information message containing the requested information. This messaging exchange may occur over LPP or some other sensing protocol.

Generally, the message call flows illustrated herein provide an example ordering of capability exchange, configuration, activation, measurements, and deactivation, etc. It will be understood that the orderings expressly shown herein are not the only possible orderings. Further, there is no intention to illustrate any mandatory sequence by examples given herein.

Embodiments where an activation of a signal transmission and a measurement request are “fused” to a single message are expressly contemplated.

Embodiments where multiple measurement requests occur between activation and deactivation are expressly contemplated.

With respect to bi-directional bistatic and/or multistatic sensing, a relative ordering of two sensing signal transmissions may not be particularly defined for some cases. For example, depending on an applicable integration level, there may be multiple “independent” sessions, some clearly defined sequence(s), or some intertwined transmission of sensing signals (e.g. based on comb-like structures). In such cases, applicable capabilities of the UE may include a switching time between transmit and receive and/or processing time requirements. An SeMF may be responsible for coordination of the different nodes (e.g., may ensure that a node does not have to transmit and receive sensing signals simultaneously if it is not capable of simultaneous transmit and receive operation).

Each node may be able to handle multiple such sessions simultaneously, for example, with different peers, simultaneous monostatic and bistatic sensing, etc.

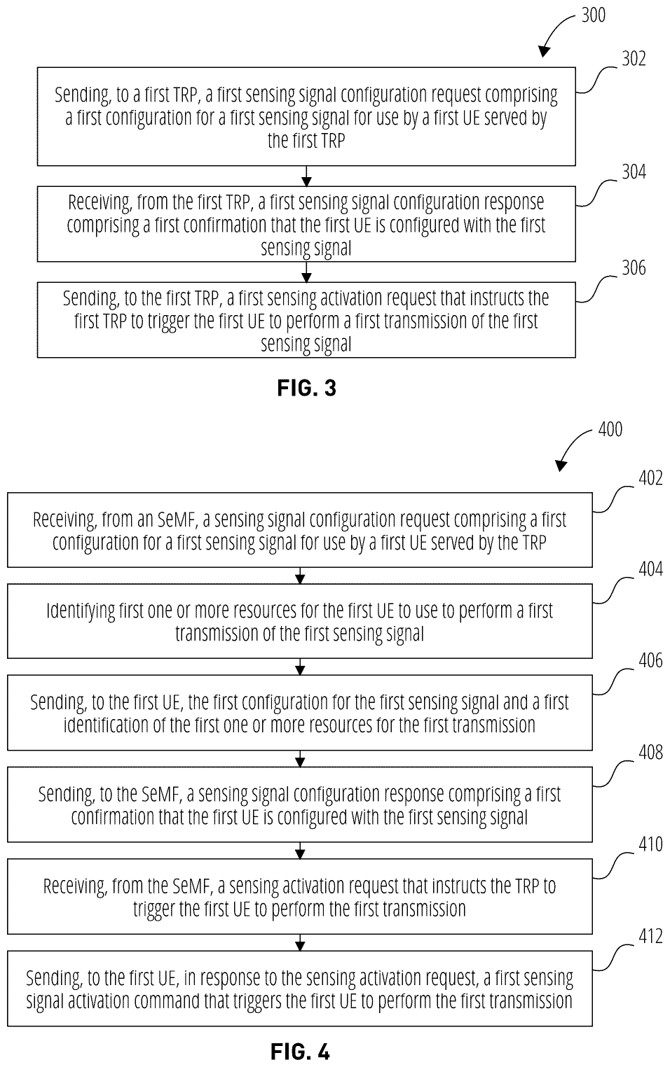

FIG. 3 illustrates a method 300 of an SeMF, according to embodiments discussed herein. The method 300 includes sending 302, to a first TRP, a first sensing signal configuration request comprising a first configuration for a first sensing signal for use by a first UE served by the first TRP. The method 300 further includes receiving 304, from the first TRP, a first sensing signal configuration response comprising a first confirmation that the first UE is configured with the first sensing signal. The method 300 further includes sending 306, to the first TRP, a first sensing activation request that instructs the first TRP to trigger the first UE to perform a first transmission of the first sensing signal.

In some embodiments, the method 300 further includes receiving, from the first UE, a first sensing result that is based on a first sensing measurement of the first sensing signal performed by the first UE; and providing, to a sensing client of the SeMF, the first sensing result.

In some such embodiments, the first sensing signal configuration request further comprises a second configuration for a second sensing signal for use by a second UE served by the first TRP; the first sensing signal configuration response further comprises a second confirmation that the second UE is configured with the second sensing signal; and the first activation request further instructs the first TRP to trigger the second UE to perform a second transmission of the second sensing signal; and the method 300 further includes: receiving, from the second UE, a second sensing result that is based on a second sensing measurement of the second sensing signal performed by the second UE; and providing, to the sensing client, the second sensing result. In some of these cases, the method 300 further includes confirming that the second sensing signal is orthogonal to the first sensing signal.

In some such embodiments, the method 300 further includes sending, to a second TRP, a second sensing signal configuration request comprising a second configuration for a second sensing signal for use by a second UE served by the second TRP; receiving, from the second TRP, a second sensing signal configuration response comprising a second confirmation that the second UE is configured with the second sensing signal; sending, to the second TRP, a second activation request that instructs the second TRP to trigger the second UE to perform a second transmission of the second sensing signal; receiving, from the second UE, a second sensing result that is based on a second sensing measurement of the second sensing signal performed by the second UE; and providing, to the sensing client, the second sensing result. In some of these cases, the method 300 further includes confirming that the second sensing signal is orthogonal to the first sensing signal.

In some such embodiments, the method 300 further includes transmitting a sensing information request that triggers the first UE to generate the first sensing measurement of the first sensing signal and that indicates a timing for the first transmission of the first sensing signal.

In some such embodiments, the method 300 further includes transmitting a sensing information request that indicates a reporting type for use to send the first sensing result to the SeMF, wherein the reporting type comprises one of an individual reporting type, a combined reporting type, and a threshold-based reporting type.

In some embodiments, the method 300 further includes performing a sensing information exchange with the first TRP during which the SeMF receives, from the first TRP, one or more of: a sensing method configuration capability of the first TRP; a sensing carrier frequency configuration capability of the first TRP; a sensing bandwidth configuration capability of the first TRP; and a sensing signal configuration capability of the first TRP.

In some embodiments, the method 300 further includes performing a capability transfer with the first UE during which the SeMF receives, from the first UE, one or more of: a sensing method capability of the first UE; a sensing carrier frequency capability of the first UE; a sensing bandwidth capability of the first UE; a sensing pre-processing capability of the first UE; a sensing assistance data capability of the first UE; a sensing transmit configuration capability of the first UE;
a sensing receive configuration capability of the first UE; and a sensing KPI of the first UE.

In some embodiments of the method 300, the first configuration for the first sensing signal identifies a reference signal type of the first sensing signal.

In some embodiments of the method 300, the first configuration for the first sensing signal indicates that a data communication signal of the first UE is the first sensing signal.

In some embodiments of the method 300, the first configuration for the first sensing signal indicates one or more of: a number of MIMO streams used by the first sensing signal; and one or more forms for the MIMO streams used by the first sensing signal.

In some embodiments of the method 300, the first configuration for the first sensing signal indicates a resource set ID for the first sensing signal.

In some embodiments of the method 300, the first configuration for the first sensing signal comprises beam information for the first sensing signal.

In some embodiments of the method 300, the first configuration for the first sensing signal comprises frequency information for the first sensing signal.

In some embodiments of the method 300, the first sensing activation request comprises a periodicity configuration for the first sensing signal.

In some embodiments of the method 300, the first sensing activation request comprises a periodicity configuration for the first sensing signal.

In some embodiments of the method 300, the first sensing activation request indicates a timing for the first transmission of the first sensing signal.

In some embodiments, the method 300 further includes transmitting a sensing information request that triggers the first UE to generate the first sensing measurement of the first sensing signal. In some such embodiments, the sensing information request comprises a measurement type configuration for one or more measurements that are performed at the first UE, the one or more measurements includes the first measurement, and the measurement type setting indicates one of a single-shot measurement type, a semi-persistent measurement type, and a periodic measurement type.

FIG. 4 illustrates a method 400 of a TRP, according to embodiments discussed herein. The method 400 includes receiving 402, from an SeMF, a sensing signal configuration request comprising a first configuration for a first sensing signal for use by a first UE served by the TRP. The method 400 further includes identifying 404 first one or more resources for the first UE to use to perform a first transmission of the first sensing signal. The method 400 further includes sending 406, to the first UE, the first configuration for the first sensing signal and a first identification of the first one or more resources for the first transmission. The method 400 further includes sending 408, to the SeMF, a sensing signal configuration response comprising a first confirmation that the first UE is configured with the first sensing signal. The method 400 further includes receiving 410, from the SeMF, a sensing activation request that instructs the TRP to trigger the first UE to perform the first transmission. The method 400 further includers sending 412, to the first UE, in response to the sensing activation request, a first sensing signal activation command that triggers the first UE to perform the first transmission.

In some embodiments, the method 400 further includes sending, to a second UE, the first configuration for the first sensing signal and the first identification of the first one or more resources for the first transmission; and sending, to the second UE, a second sensing signal activation command that triggers the second UE to perform sensing of the first sensing signal.

In some embodiments of the method 400, the sensing signal configuration request further comprises a second configuration for a second sensing signal for use by a second UE served by the TRP; the sensing signal configuration response further comprises a second confirmation that the second UE is configured with the second sensing signal; and the sensing activation request further instructs the TRP to trigger the second UE to perform a second transmission of the second sensing signal; and the method 400 further includes: identifying second one or more resources for the second UE to use to perform the second transmission of the second sensing signal; sending, to the second UE, the second configuration for the second sensing signal and a second identification of the second one or more resources for the second transmission; and sending, to the second UE, a second sensing signal activation command that triggers the second UE to perform the second transmission.

In some embodiments, the method 400 further includes performing a sensing information exchange with the SeMF, during which the TRP sends, to the SeMF, one or more of: a sensing method configuration capability of the TRP; a sensing carrier frequency configuration capability of the TRP; a sensing bandwidth configuration capability of the TRP; and a sensing signal configuration capability of the TRP.

In some embodiments of the method 400, the first configuration for the first sensing signal identifies a reference signal type of the first sensing signal.

In some embodiments of the method 400, the first configuration for the first sensing signal indicates that a data communication signal of the first UE is the first sensing signal.

In some embodiments of the method 400, the first configuration for the first sensing signal indicates one or more of: a number of MIMO streams used by the first sensing signal; and one or more forms for the MIMO streams used by the first sensing signal.

In some embodiments of the method 400, the first configuration for the first sensing signal indicates a resource set ID for the first sensing signal.

In some embodiments of the method 400, the first configuration for the first sensing signal comprises beam information for the first sensing signal.

In some embodiments of the method 400, the first configuration for the first sensing signal comprises frequency information for the first sensing signal.

In some embodiments of the method 400, the sensing activation request comprises a periodicity configuration for the first sensing signal.

In some embodiments of the method 400, the sensing activation request indicates a timing for the first transmission of the first sensing signal.

In some embodiments of the method 400, the first sensing signal activation command comprises a periodicity configuration for the first sensing signal.

In some embodiments of the method 400, the first sensing signal activation command indicates a timing for the first transmission of the first sensing signal.

In some embodiments of the method 400, the first sensing signal activation command triggers the first UE to generate the first sensing measurement of the first sensing signal.

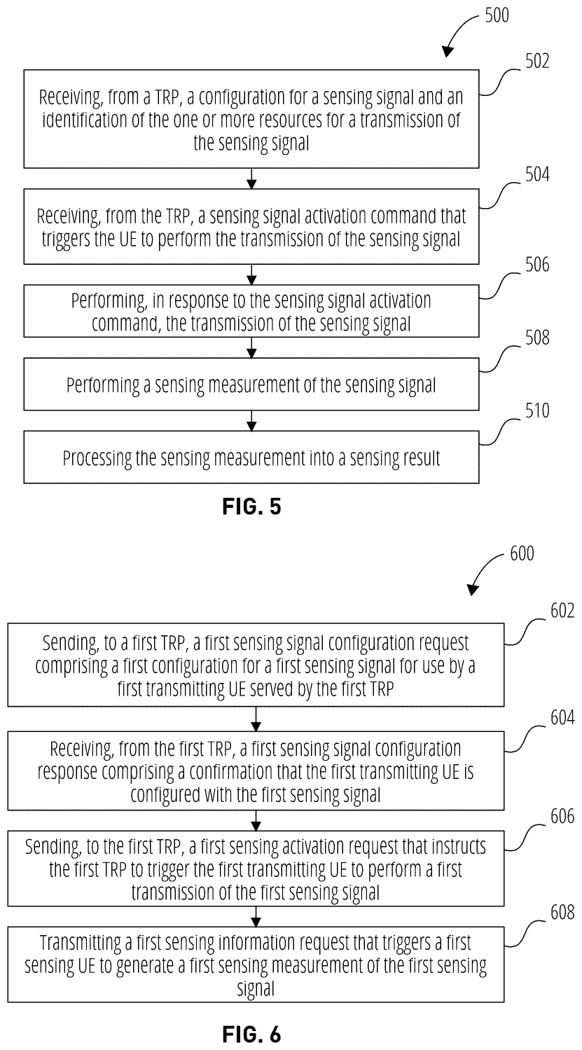

FIG. 5 illustrates a method 500 of a UE, according to embodiments discussed herein. The method 500 includes receiving 502, from a TRP, a configuration for a sensing signal and an identification of the one or more resources for a transmission of the sensing signal. The method 500 further includes receiving 504, from the TRP, a sensing signal activation command that triggers the UE to perform the transmission of the sensing signal. The method 500 further includes performing 506, in response to the sensing signal activation command, the transmission of the sensing signal. The method 500 further includes performing 508 a sensing measurement of the sensing signal. The method 500 further includes processing 510 the sensing measurement into a sensing result.

In some embodiments, the method 500 further includes sending, to an SeMF, the sensing result.

In some embodiments, the method 500 further includes receiving, from an SeMF, a sensing information request that triggers the UE to generate the sensing measurement of the sensing signal.

In some embodiments, the method 500 further includes performing a capability transfer with an SeMF during which the UE sends, to the SeMF, one or more of: a sensing method capability of the UE; a sensing carrier frequency capability of the UE; a sensing bandwidth capability of the UE; a sensing pre-processing capability of the UE; a sensing assistance data capability of the UE; a sensing transmit configuration capability of the UE; a sensing receive configuration capability of the UE; and a sensing KPI of the UE.

In some embodiments of the method 500, the configuration for the sensing signal identifies a reference signal type of the sensing signal.

In some embodiments of the method 500, the configuration for the sensing signal indicates that a data communication signal of the UE is the sensing signal.

In some embodiments of the method 500, the configuration for the sensing signal indicates one or more of: a number of MIMO streams used by the sensing signal; and one or more forms for the MIMO streams used by the sensing signal.

In some embodiments of the method 500, the configuration for the sensing signal indicates a resource set ID for the sensing signal.

In some embodiments of the method 500, the configuration for the sensing signal comprises beam information for the sensing signal.

In some embodiments of the method 500, the configuration for the sensing signal comprises frequency information for the sensing signal.

In some embodiments of the method 500, the sensing signal activation command comprises a periodicity configuration for the sensing signal.

In some embodiments of the method 500, the sensing signal activation command comprises a periodicity configuration for the sensing signal.

In some embodiments of the method 500, the sensing signal activation command triggers the UE to generate the sensing measurement of the sensing signal.

In some embodiments, the method 500 further includes receiving, from an SeMF, a sensing information request that triggers the UE to generate the sensing measurement of the sensing signal.

In some embodiments of the method 500, the sensing information request indicates a requested sensing result type for the sensing result.

In some embodiments of the method 500, the sensing information request indicates a reporting type to use to send the sensing result to an SeMF, wherein the reporting type comprises one of an individual reporting type, a combined reporting type, and a threshold-based reporting type.

FIG. 6 illustrates a method 600 of an SeMF, according to embodiments discussed herein. The method 600 includes sending 602, to a first TRP, a first sensing signal configuration request comprising a first configuration for a first sensing signal for use by a first transmitting UE served by the first TRP. The method 600 further includes receiving 604, from the first TRP, a first sensing signal configuration response comprising a confirmation that the first transmitting UE is configured with the first sensing signal. The method 600 further includes sending 606, to the first TRP, a first sensing activation request that instructs the first TRP to trigger the first transmitting UE to perform a first transmission of the first sensing signal. The method 600 further includes transmitting 608 a first sensing information request that triggers a first sensing UE to generate a first sensing measurement of the first sensing signal.

In some embodiments, the method 600 further includes receiving, from the first sensing UE, a first sensing result that is based on the first sensing measurement performed by the first sensing UE; and providing, to a sensing client of the SeMF, the first sensing result.

In some such embodiments, the sensing information request further triggers a second sensing UE to generate a second sensing measurement of the first sensing signal; and further comprising: receiving, from the second sensing UE, a second sensing result that is based on the second sensing measurement performed by the second sensing UE; and providing to the sensing client of the SeMF, the second sensing result.

In some such embodiments, the first sensing signal configuration request further comprises a second configuration for a second sensing signal for use by a second transmitting UE served by the first TRP; the first sensing signal configuration response further comprises a second confirmation that the second transmitting UE is configured with the second sensing signal; the first activation request further instructs the first TRP to trigger the second transmitting UE to perform a second transmission of the second sensing signal; the sensing information request further triggers the first sensing UE to generate a second sensing measurement of the sensing signal; and the method 600 further includes: receiving, from the first sensing UE, a second sensing result that is based on a second sensing measurement of the second sensing signal performed by the first sensing UE; and providing, to the sensing client, the second sensing result. In some of these cases, the method 600 further includes confirming that the second sensing signal is orthogonal to the first sensing signal.

In some such embodiments, the first sensing signal configuration request further comprises a second configuration for a second sensing signal for use by a second transmitting UE served by the first TRP; the first sensing signal configuration response further comprises a second confirmation that the second transmitting UE is configured with the second sensing signal; the first activation request further instructs the first TRP to trigger the second transmitting UE to perform a second transmission of the second sensing signal; the sensing information request further triggers a second sensing UE to generate a second sensing measurement of the sensing signal; and the method 600 further includes: receiving, from the second sensing UE, a second sensing result that is based on a second sensing measurement of the second sensing signal performed by the second sensing UE; and providing, to the sensing client, the second sensing result. In some such cases, the method 600 further includes confirming that the second sensing signal is orthogonal to the first sensing signal.

In some such embodiments, the method 600 further includes sending, to a second TRP, a second sensing signal configuration request comprising a second configuration for a second sensing signal for use by a second transmitting UE served by the second TRP; receiving, from the second TRP, a second sensing signal configuration response comprising a second confirmation that the second transmitting UE is configured with the second sensing signal; sending, to the second TRP, a second activation request that instructs the second TRP to trigger the second transmitting UE to perform a second transmission of the second sensing signal; transmitting a second sensing information request that triggers a second sensing UE to generate a second sensing measurement of the second sensing signal; receiving, from the second sensing UE, a second sensing result that is based on the second sensing measurement of the second sensing signal performed by the second sensing UE; and providing, to the sensing client, the second sensing result. In some such cases, the method 600 further includes confirming that the second sensing signal is orthogonal to the first sensing signal.

In some such embodiments, the method 600 further includes transmitting a first sensing information request that triggers a second sensing UE that is served by a second TRP to generate a second sensing measurement of the first sensing signal; receiving, from the second sensing UE, a second sensing result that is based on the second sensing measurement performed by the second sensing UE; and providing, to a sensing client of the SeMF, the second sensing result.

In some such embodiments, the sensing information request indicates a requested sensing result type for the first sensing result.

In some such embodiments, the sensing information request indicates a reporting type to use to send the first sensing result to the SeMF, wherein the reporting type comprises one of an individual reporting type, a combined reporting type, and a threshold-based reporting type.

In some embodiments, the method 600 further includes performing a sensing information exchange with the first TRP during which the SeMF receives, from the first TRP, one or more of: a sensing method configuration capability of the first TRP; a sensing carrier frequency configuration capability of the first TRP; a sensing bandwidth configuration capability of the first TRP; and a sensing signal configuration capability of the first TRP.

In some embodiments, the method 600 further includes performing a capability transfer with one of the transmitting UE and the sensing UE during which the SeMF receives, from the one of the transmitting UE and the sensing UE, one or more of: a sensing method capability of the one of the transmitting UE and the sensing UE; a sensing carrier frequency capability of the one of the transmitting UE and the sensing UE; a sensing bandwidth capability of the one of the transmitting UE and the sensing UE; a sensing pre-processing capability of the one of the transmitting UE and the sensing UE; a sensing assistance data capability of the one of the transmitting UE and the sensing UE; a sensing transmit configuration capability of the one of the transmitting UE and the sensing UE; a sensing receive configuration capability of the one of the transmitting UE and the sensing UE; and a sensing KPI of the one of the transmitting UE and the sensing UE.

In some embodiments of the method 600, the first configuration for the first sensing signal identifies a reference signal type of the first sensing signal.

In some embodiments of the method 600, the first configuration for the first sensing signal indicates that a data communication signal of the transmitting UE is the first sensing signal.

In some embodiments of the method 600, the first configuration for the first sensing signal indicates one or more of: a number of MIMO streams used by the first sensing signal; and one or more forms for the MIMO streams used by the first sensing signal.

In some embodiments of the method 600, the first configuration for the first sensing signal indicates a resource set ID for the first sensing signal.

In some embodiments of the method 600, the first configuration for the first sensing signal comprises beam information for the first sensing signal.

In some embodiments of the method 600, the first configuration for the first sensing signal comprises frequency information for the first sensing signal.

In some embodiments of the method 600, the first sensing activation request comprises a periodicity configuration for the first sensing signal.

In some embodiments of the method 600, the first sensing activation request indicates a timing for the first transmission of the first sensing signal.

In some embodiments of the method 600, the sensing information request further triggers the transmitting UE to send assistance data comprising one of a position of the transmitting UE and an orientation of the transmitting UE to the SeMF, and further comprising receiving, from the transmitting UE, the assistance data.

In some embodiments of the method 600, the sensing information request comprises a measurement type configuration for one or more measurements that are performed at the sensing UE, the one or more measurements includes the first measurement, and the measurement type setting indicates one of a single-shot measurement type, a semi-persistent measurement type, and a periodic measurement type.

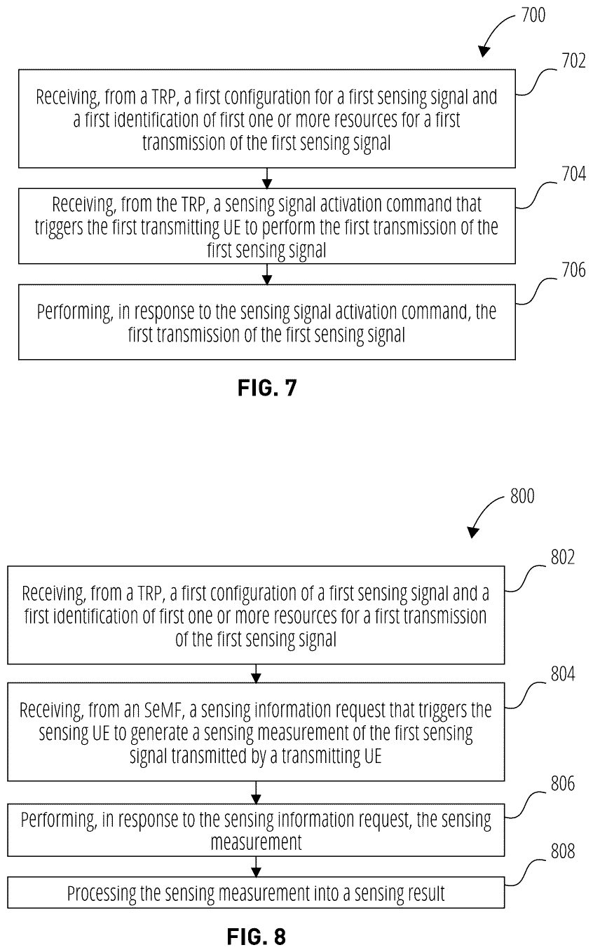

FIG. 7 illustrates a method 700 of a UE, according to embodiments discussed herein. The method 700 includes receiving 702, from a TRP, a first configuration for a first sensing signal and a first identification of first one or more resources for a first transmission of the first sensing signal. The method 700 further includes receiving 704, from the TRP, a sensing signal activation command that triggers the first transmitting UE to perform the first transmission of the first sensing signal. The method 700 further includes performing 706, in response to the sensing signal activation command, the first transmission of the first sensing signal.

In some embodiments, the method 700 further includes performing a capability transfer with an SeMF during which the transmitting UE sends, to the SeMF, one or more of: a sensing method capability of the first transmitting UE; a sensing carrier frequency capability of the first transmitting UE; a sensing bandwidth capability of the first transmitting UE; a sensing pre-processing capability of the first transmitting UE; a sensing assistance data capability of the first transmitting UE; a sensing transmit configuration capability of the first transmitting UE; a sensing receive configuration capability of the first transmitting UE; and a sensing KPI of the first transmitting UE.

In some embodiments of the method 700, the first configuration for the first sensing signal identifies a reference signal type of the first sensing signal.

In some embodiments of the method 700, the first configuration for the first sensing signal indicates that a data communication signal of the transmitting UE is the first sensing signal.

In some embodiments of the method 700, the first configuration for the first sensing signal indicates one or more of: a number of MIMO streams used by the first sensing signal; and one or more forms for the MIMO streams used by the first sensing signal.

In some embodiments of the method 700, the first configuration for the first sensing signal indicates a resource set ID for the first sensing signal.

In some embodiments of the method 700, the first configuration for the first sensing signal comprises beam information for the first sensing signal.

In some embodiments of the method 700, the first configuration for the first sensing signal comprises frequency information for the first sensing signal.

In some embodiments of the method 700, the sensing signal activation command comprises a periodicity configuration for the first sensing signal.

In some embodiments of the method 700, the sensing signal activation command indicates a timing for the first transmission of the first sensing signal.

In some embodiments of the method 700, receiving, from the TRP, a second configuration of a second sensing signal and a second identification of second one or more resources for a second transmission of the first sensing signal; receiving, from an SeMF, a sensing information request that triggers the first transmitting UE to generate a sensing measurement of a second sensing signal transmitted by a second transmitting UE; performing, in response to the sensing information request, the sensing measurement; and processing the sensing measurement into a sensing result.

In some such embodiments, the sensing information request further triggers the transmitting UE to send assistance data comprising one of a position of the transmitting UE and an orientation of the transmitting UE to the SeMF, and further comprising sending, to the SeMF, the assistance data.

In some such embodiments, the method 700 further includes sending, to the SeMF, the sensing result. In some of these cases, the sensing information request indicates a requested sensing result type for the sensing result. In some of these cases, the sensing information request indicates a reporting type to use to send the sensing result to the SeMF, wherein the reporting type comprises one of an individual reporting type, a combined reporting type, and a threshold-based reporting type.

FIG. 8 illustrates a method 800 of a UE, according to embodiments discussed herein. The method 800 includes receiving 802, from a TRP, a first configuration of a first sensing signal and a first identification of first one or more resources for a first transmission of the first sensing signal. The method 800 further includes receiving 804, from an SeMF, a sensing information request that triggers the sensing UE to generate a sensing measurement of the first sensing signal transmitted by a transmitting UE. The method 800 further includes performing 806, in response to the sensing information request, the sensing measurement. The method 800 further includes processing 808 the sensing measurement into a sensing result.

In some embodiments of the method 800, the sensing information request further triggers the sensing UE to send assistance data comprising one of a position of the sensing UE and an orientation of the sensing UE to the SeMF, and further comprising sending, to the SeMF, the assistance data.

In some embodiments, the method 800 further includes sending, to the SeMF, the sensing result.

In some such embodiments, the sensing information request indicates a requested sensing result type for the sensing result.

In some such embodiments, the sensing information request indicates a reporting type to use to send the sensing result to the SeMF, wherein the reporting type comprises one of an individual reporting type, a combined reporting type, and a threshold-based reporting type.

In some embodiments, the method 800 further includes receiving, from the TRP, a second configuration for a second sensing signal and a second identification of second one or more resources for a second transmission of the second sensing signal; receiving, from the TRP, a sensing signal activation command that triggers the sensing UE to perform the second transmission of the second sensing signal; and performing, in response to the sensing signal activation command, the second transmission of the second sensing signal.

In some such embodiments, the method 800 further includes performing a capability transfer with the SeMF during which the sensing UE sends, to the SeMF, one or more of: a sensing method capability of the sensing UE; a sensing carrier frequency capability of the sensing UE; a sensing bandwidth capability of the sensing UE; a sensing pre-processing capability of the sensing UE; a sensing assistance data capability of the sensing UE; a sensing transmit configuration capability of the sensing UE; a sensing receive configuration capability of the sensing UE; and a sensing KPI of the sensing UE.

In some such embodiments, the configuration for the second sensing signal identifies a reference signal type of the second sensing signal.

In some such embodiments, the configuration for the second sensing signal indicates that a data communication signal of the sensing UE is the second sensing signal.

In some such embodiments, the configuration for the second sensing signal indicates one or more of: a number of MIMO streams used by the second sensing signal; and one or more forms for the MIMO streams used by the second sensing signal.

In some such embodiments, the configuration for the second sensing signal indicates a resource set ID for the second sensing signal.

In some such embodiments, the configuration for the second sensing signal comprises beam information for the second sensing signal.

In some such embodiments, the configuration for the second sensing signal comprises frequency information for the second sensing signal.

In some such embodiments, the sensing signal activation command comprises a periodicity configuration for the second sensing signal.

In some such embodiments, the sensing signal activation command indicates a timing for the second transmission of the second sensing signal.

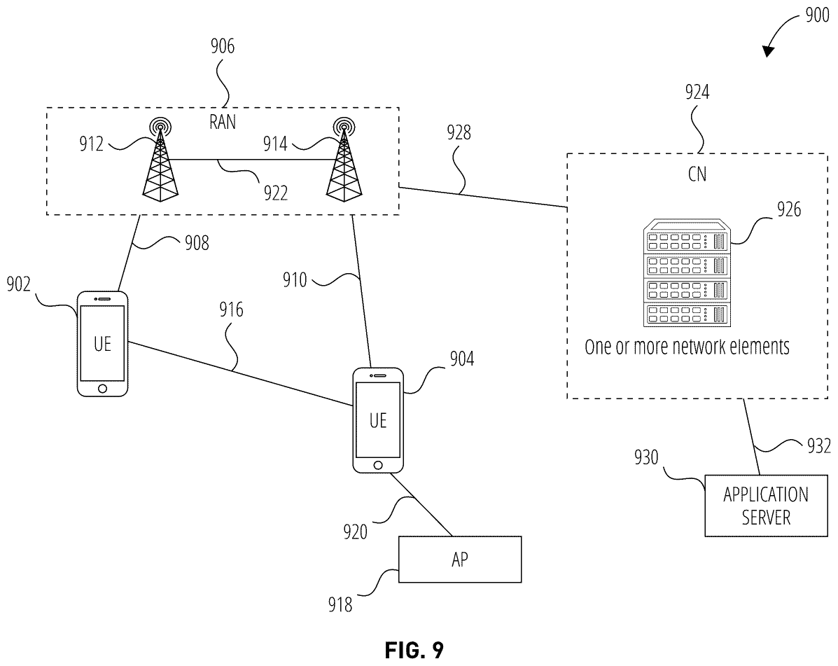

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

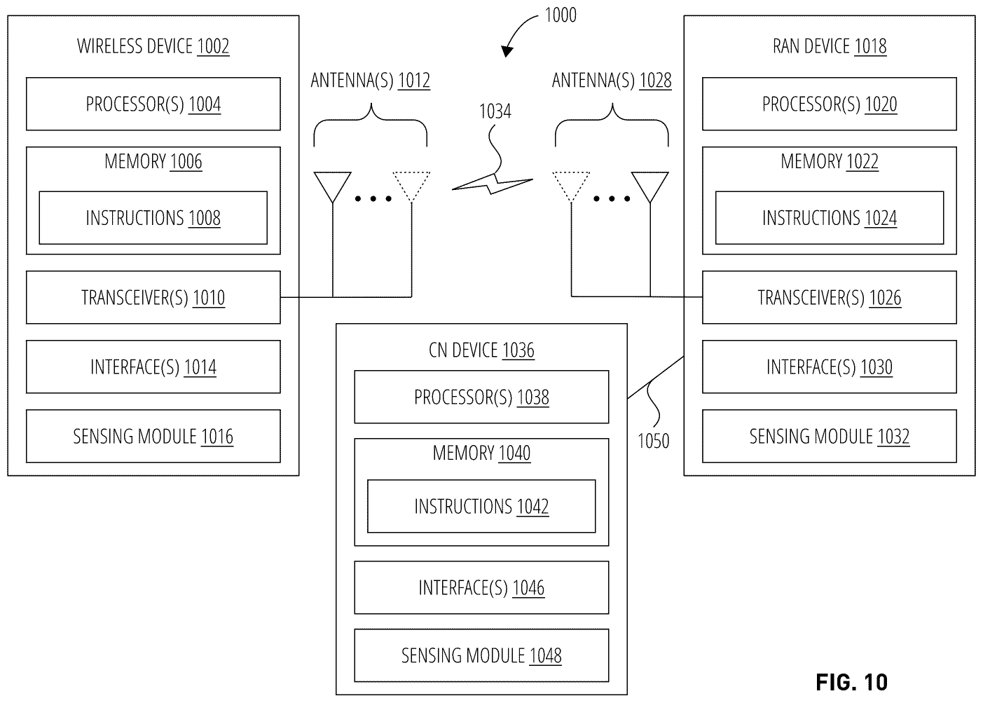

FIG. 10 illustrates a system 1000 for performing signaling 1034 between a wireless device 1002, a RAN device 1018, and a CN device 1036, according to embodiments disclosed herein. The system 1000 may be a portion of a wireless communications system as herein described. The wireless device 1002 may be, for example, a UE of a wireless communication system. The RAN device 1018 may be, for example, a base station (e.g., an eNB or a gNB) and/or a TRP of a wireless communication system. The CN device 1036 may operate a network function (such as an SeMF) used in the wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter circuitry and/or receiver circuitry that use the antenna(s) 1012 of the wireless device 1002 to facilitate signaling (e.g., the signaling 1034) to and/or from the wireless device 1002 with other devices (e.g., the RAN device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a sensing module 1016. The sensing module 1016 may be implemented via hardware, software, or combinations thereof. For example, the sensing module 1016 may be implemented as a processor, circuit, and/or instructions 1008 stored in the memory 1006 and executed by the processor(s) 1004. In some examples, the sensing module 1016 may be integrated within the processor(s) 1004 and/or the transceiver(s) 1010. For example, the sensing module 1016 may be implemented by a combination of software components (e.g., executed by a DSP or a general processor) and hardware components (e.g., logic gates and circuitry) within the processor(s) 1004 or the transceiver(s) 1010.

The sensing module 1016 may be used for various aspects of the present disclosure, for example, aspects of FIG. 5, FIG. 7, and/or FIG. 8, as discussed herein. For example, the sensing module 1016 may configure a wireless device 1002 to receive, from a TRP, a configuration for a sensing signal and an identification of the one or more resources for a transmission of the sensing signal; receive, from the TRP, a sensing signal activation command that triggers the UE to perform the transmission of the sensing signal; perform, in response to the sensing signal activation command, the transmission of the sensing signal; perform a sensing measurement of the sensing signal; and process the sensing measurement into a sensing result. As another example, the sensing module 1016 may configure a wireless device 1002 to receive, from a TRP, a first configuration for a first sensing signal and a first identification of first one or more resources for a first transmission of the first sensing signal; receive, from the TRP, a sensing signal activation command that triggers the first transmitting UE to perform the first transmission of the first sensing signal; and perform, in response to the sensing signal activation command, the first transmission of the first sensing signal. As another example, the sensing module 1016 may configure a wireless device 1002 to receive, from a TRP, a first configuration of a first sensing signal and a first identification of first one or more resources for a first transmission of the first sensing signal; receive, from an SeMF, a sensing information request that triggers the sensing UE to generate a sensing measurement of the first sensing signal transmitted by a transmitting UE; perform, in response to the sensing information request, the sensing measurement; and process the sensing measurement into a sensing result.

The RAN device 1018 may include one or more processor(s) 1020. The processor(s) 1020 may execute instructions such that various operations of the RAN device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The RAN device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The RAN device 1018 may include one or more transceiver(s) 1026 that may include RF transmitter circuitry and/or receiver circuitry that use the antenna(s) 1028 of the RAN device 1018 to facilitate signaling (e.g., the signaling 1034) to and/or from the RAN device 1018 with other devices (e.g., the wireless device 1002) according to corresponding RATs.

The RAN device 1018 may include one or more antenna(s) 1028 (e.g., one, two, four, or more). In embodiments having multiple antenna(s) 1028, the RAN device 1018 may perform MIMO, digital beamforming, analog beamforming, beam steering, etc., as has been described.

The RAN device 1018 may include one or more interface(s) 1030. The interface(s) 1030 may be used to provide input to or output from the RAN device 1018. For example, a RAN device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The RAN device 1018 may include a sensing module 1032. The sensing module 1032 may be implemented via hardware, software, or combinations thereof. For example, the sensing module 1032 may be implemented as a processor, circuit, and/or instructions 1024 stored in the memory 1022 and executed by the processor(s) 1020. In some examples, the sensing module 1032 may be integrated within the processor(s) 1020 and/or the transceiver(s) 1026. For example, the sensing module 1032 may be implemented by a combination of software components (e.g., executed by a DSP or a general processor) and hardware components (e.g., logic gates and circuitry) within the processor(s) 1020 or the transceiver(s) 1026.

The sensing module 1032 may be used for various aspects of the present disclosure, for example, aspects of FIG. 4. For example, the sensing module 1032 may configure a RAN device 1018 that is a TRP/base station to receive, from an SeMF, a sensing signal configuration request comprising a first configuration for a first sensing signal for use by a first UE served by the TRP; identify first one or more resources for the first UE to use to perform a first transmission of the first sensing signal; send, to the first UE, the first configuration for the first sensing signal and a first identification of the first one or more resources for the first transmission; send, to the SeMF, a sensing signal configuration response comprising a first confirmation that the first UE is configured with the first sensing signal; receive, from the SeMF, a sensing activation request that instructs the TRP to trigger the first UE to perform the first transmission; and send, to the first UE, in response to the sensing activation request, a first sensing signal activation command that triggers the first UE to perform the first transmission.

The CN device 1036 may include one or more processor(s) 1038. The processor(s) 1038 may execute instructions such that various operations of the CN device 1036 are performed, as described herein. The CN device 1036 may host, in whole or in part, one or more CN functions (also sometimes referred to as network functions).

The processor(s) 1038 may include a memory 1040. The memory 1040 may be a non-transitory computer-readable storage medium that stores instructions 1042 (which may include, for example, the instructions being executed by the processor(s) 1038). The instructions 1042 may also be referred to as program code or a computer program. The memory 1040 may also store data used by, and results computed by, the processor(s) 1038.

The CN device 1036 may include one or more interface(s) 1046. The interface(s) 1046 may be used to provide input to or output from the CN device 1036. For example, the interface(s) 1046 may enable the CN device 1036 to communicate with RAN devices (e.g., as illustrated, the CN device 1036 uses a first interface 1050 to communicate with the RAN device 1018. One or more of the interface(s) 1046 may also be used by the CN device 1036 to communicate with external networks, computers, databases, and the like for purposes of corresponding operations of the CN device 1036.

The processor(s) 1038 may include a sensing module 1048. The sensing module 1048 may be implemented via hardware, software, or combinations thereof. For example, the sensing module 1048 may be implemented as a processor, circuit, and/or instructions 1042 stored in the memory 1040 and executed by the processor(s) 1038. In some examples, the sensing module 1048 may be integrated within the processor(s) 1038. For example, the sensing module 1048 may be implemented by a combination of software components (e.g., executed by a DSP or a general processor) and hardware components (e.g., logic gates and circuitry) within the processor(s) 1038.

The sensing module 1048 may be used for various aspects of the present disclosure, for example, aspects of FIG. 3 and FIG. 6. For example, the sensing module 1048 may configure the CN device 1036 to send, a first sensing signal configuration request comprising a first configuration for a first sensing signal for use by a first UE served by the first TRP; receive, from the first TRP, a first sensing signal configuration response comprising a first confirmation that the first UE is configured with the first sensing signal; and send, to the first TRP, a first sensing activation request that instructs the first TRP to trigger the first UE to perform a first transmission of the first sensing signal. In another example, the sensing module 1048 may configure the CN device 1036 to send, to a first TRP, a first sensing signal configuration request comprising a first configuration for a first sensing signal for use by a first transmitting UE served by the first TRP; receive, from the first TRP, a first sensing signal configuration response comprising a confirmation that the first transmitting UE is configured with the first sensing signal; send, to the first TRP, a first sensing activation request that instructs the first TRP to trigger the first transmitting UE to perform a first transmission of the first sensing signal; and transmit a first sensing information request that triggers a first sensing UE to generate a first sensing measurement of the first sensing signal.

Embodiments contemplated herein include an apparatus comprising means to perform one or more elements of any one or more of the method 500, the method 700, and/or the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of any one or more of the method 500, the method 700, and/or the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of any one or more of the method 500, the method 700, and/or the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of any one or more of the method 500, the method 700, and/or the method 800. This apparatus may be, for example, an apparatus of a UE (such as a wireless device 1002 that is a UE, as described herein).

Embodiments contemplated herein include a signal as described in or related to one or more elements of any one or more of the method 500, the method 700, and/or the method 800.

Embodiments contemplated herein include a computer program or computer program product comprising instructions, wherein execution of the program by a processor is to cause the processor to carry out one or more elements of any one or more of the method 500, the method 700, and/or the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of the method 400. This apparatus may be, for example, an apparatus of a base station (such as a RAN device 1018 that is a base station and/or a TRP, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a base station (such as a memory 1022 of a RAN device 1018 that is a base station and/or a TRP, as described herein).

Embodiments contemplated herein include an apparatus comprising logic, modules, or circuitry to perform one or more elements of the method 400. This apparatus may be, for example, an apparatus of a base station (such as a RAN device 1018 that is a base station and/or a TRP, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a base station (such as a RAN device 1018 that is a base station and/or a TRP, as described herein).

Embodiments contemplated herein include a signal as described in or related to one or more elements of the method 400.

Embodiments contemplated herein include a computer program or computer program product comprising instructions, wherein execution of the program by a processing element is to cause the processing element to carry out one or more elements of the method 400. The processor may be a processor of a base station (such as a processor(s) 1020 of a RAN device 1018 that is a base station and/or a TRP, as described herein). These instructions may be, for example, located in the processor and/or on a memory of the base station (such as a memory 1022 of a RAN device 1018 that is a base station and/or a TRP, as described herein).

Embodiments contemplated herein include an apparatus comprising means to perform one or more elements of any one or more of the method 300 and the method 600. This apparatus may be, for example, an apparatus of a CN (such as a CN device 1036, as described herein).

Embodiments contemplated herein include one or more non-transitory computer-readable media comprising instructions to cause an electronic device, upon execution of the instructions by one or more processors of the electronic device, to perform one or more elements of any one or more of the method 300 and the method 600. This non-transitory computer-readable media may be, for example, a memory of a CN (such as a memory 1040 of a CN device 1036, as described herein).

Embodiments contemplated herein include an apparatus comprising logic, modules, or circuitry to perform one or more elements of any one or more of the method 300 and the method 600. This apparatus may be, for example, an apparatus of a CN (such as a CN device 1036, as described herein).

Embodiments contemplated herein include an apparatus comprising: one or more processors and one or more computer-readable media comprising instructions that, when executed by the one or more processors, cause the one or more processors to perform one or more elements of any one or more of the method 300 and the method 600. This apparatus may be, for example, an apparatus of a CN (such as a CN device 1036, as described herein).

Embodiments contemplated herein include a signal as described in or related to one or more elements of any one or more of the method 300 and the method 600.

Embodiments contemplated herein include a computer program or computer program product comprising instructions, wherein execution of the program by a processing element is to cause the processing element to carry out one or more elements of any one or more of the method 300 and the method 600. The processor may be a processor of a CN (such as a processor(s) 1038 of a CN device 1036, as described herein). These instructions may be, for example, located in the processor and/or on a memory of the CN (such as a memory 1040 of a CN device 1036, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a sensing management function (SeMF), comprising:
sending, to a first transmission reception point (TRP), a first sensing signal configuration request comprising a first configuration for a first sensing signal for use by a first user equipment (UE) served by the first TRP;
receiving, from the first TRP, a first sensing signal configuration response comprising a first confirmation that the first UE is configured with the first sensing signal; and
sending, to the first TRP, a first sensing activation request that instructs the first TRP to trigger the first UE to perform a first transmission of the first sensing signal.

2. The method of claim 1, further comprising:
receiving, from the first UE, a first sensing result that is based on a first sensing measurement of the first sensing signal performed by the first UE; and
providing, to a sensing client of the SeMF, the first sensing result.

3. The method of claim 2, wherein:
the first sensing signal configuration request further comprises a second configuration for a second sensing signal for use by a second UE served by the first TRP;
the first sensing signal configuration response further comprises a second confirmation that the second UE is configured with the second sensing signal; and
the first activation request further instructs the first TRP to trigger the second UE to perform a second transmission of the second sensing signal; and
further comprising:
receiving, from the second UE, a second sensing result that is based on a second sensing measurement of the second sensing signal performed by the second UE; and
providing, to the sensing client, the second sensing result.

4. The method of claim 3, further comprising confirming that the second sensing signal is orthogonal to the first sensing signal.

5. The method of claim 2, further comprising:
sending, to a second TRP, a second sensing signal configuration request comprising a second configuration for a second sensing signal for use by a second UE served by the second TRP;
receiving, from the second TRP, a second sensing signal configuration response comprising a second confirmation that the second UE is configured with the second sensing signal;
sending, to the second TRP, a second activation request that instructs the second TRP to trigger the second UE to perform a second transmission of the second sensing signal;
receiving, from the second UE, a second sensing result that is based on a second sensing measurement of the second sensing signal performed by the second UE; and
providing, to the sensing client, the second sensing result.

6. The method of claim 5, further comprising confirming that the second sensing signal is orthogonal to the first sensing signal.

7. A method of a transmission reception point (TRP), comprising:
receiving, from a sensing management function (SeMF), a sensing signal configuration request comprising a first configuration for a first sensing signal for use by a first user equipment (UE) served by the TRP;
identifying first one or more resources for the first UE to use to perform a first transmission of the first sensing signal;
sending, to the first UE, the first configuration for the first sensing signal and a first identification of the first one or more resources for the first transmission;
sending, to the SeMF, a sensing signal configuration response comprising a first confirmation that the first UE is configured with the first sensing signal;
receiving, from the SeMF, a sensing activation request that instructs the TRP to trigger the first UE to perform the first transmission; and
sending, to the first UE, in response to the sensing activation request, a first sensing signal activation command that triggers the first UE to perform the first transmission.

8. The method of claim 7, further comprising:
sending, to a second UE, the first configuration for the first sensing signal and the first identification of the first one or more resources for the first transmission; and
sending, to the second UE, a second sensing signal activation command that triggers the second UE to perform sensing of the first sensing signal.

9. The method of claim 7, wherein:
the sensing signal configuration request further comprises a second configuration for a second sensing signal for use by a second UE served by the TRP;
the sensing signal configuration response further comprises a second confirmation that the second UE is configured with the second sensing signal; and
the sensing activation request further instructs the TRP to trigger the second UE to perform a second transmission of the second sensing signal; and
further comprising:
identifying second one or more resources for the second UE to use to perform the second transmission of the second sensing signal;
sending, to the second UE, the second configuration for the second sensing signal and a second identification of the second one or more resources for the second transmission; and
sending, to the second UE, a second sensing signal activation command that triggers the second UE to perform the second transmission.

10. The method of claim 7, further comprising performing a sensing information exchange with the SeMF, during which the TRP sends, to the SeMF, one or more of:
a sensing method configuration capability of the TRP;
a sensing carrier frequency configuration capability of the TRP;
a sensing bandwidth configuration capability of the TRP; and
a sensing signal configuration capability of the TRP.

11. The method of claim 7, wherein the first configuration for the first sensing signal identifies a reference signal type of the first sensing signal.

12. The method of claim 7, wherein the first configuration for the first sensing signal indicates that a data communication signal of the first UE is the first sensing signal.

13. A method of a user equipment (UE), comprising:
receiving, from a transmission reception point (TRP), a configuration for a sensing signal and an identification of the one or more resources for a transmission of the sensing signal;
receiving, from the TRP, a sensing signal activation command that triggers the UE to perform the transmission of the sensing signal;
performing, in response to the sensing signal activation command, the transmission of the sensing signal;
performing a sensing measurement of the sensing signal; and
processing the sensing measurement into a sensing result.

14. The method of claim 13, further comprising sending, to a sensing management function (SeMF), the sensing result.

15. The method of claim 13, further comprising receiving, from a sensing management function (SeMF), a sensing information request that triggers the UE to generate the sensing measurement of the sensing signal.

16. The method of claim 13, further comprising performing a capability transfer with a sensing management function (SeMF) during which the UE sends, to the SeMF, one or more of:
a sensing method capability of the UE;
a sensing carrier frequency capability of the UE;
a sensing bandwidth capability of the UE;
a sensing pre-processing capability of the UE;
a sensing assistance data capability of the UE;
a sensing transmit configuration capability of the UE;
a sensing receive configuration capability of the UE; and
a sensing key performance indicator (KPI) of the UE.

17. The method of claim 13, wherein the sensing signal activation command comprises a periodicity configuration for the sensing signal.

18. The method of claim 13, wherein the sensing signal activation command indicates a timing for the transmission of the sensing signal.

19. The method of claim 13, wherein the sensing signal activation command triggers the UE to generate the sensing measurement of the sensing signal.

20. The method of claim 13, further comprising receiving, from a sensing management function (SeMF), a sensing information request that triggers the UE to generate the sensing measurement of the sensing signal.
